(19) United States
(12) Patent Application Publication
(10) Pub. No.: US 2024/0354640 A1
(43) Pub. Date: Oct. 24, 2024

(54) BEHAVIORAL CHANGE PROMOTION DEVICE

(71) Applicant: NTT DOCOMO, INC., Tokyo (JP)

(72) Inventors: Yukimasa KANEDA, Chiyoda-ku (JP); Gentarou KATAYAMA, Chiyoda-ku (JP); Hiroshi KAWAKAMI, Chiyoda-ku (JP)

(73) Assignee: NTT DOCOMO, INC., Tokyo (JP)

(21) Appl. No.: 18/559,911

(22) PCT Filed: Jul. 26, 2022
(86) PCT No.: PCT/JP2022/028761

§ 371 Date: Nov. 9, 2023

(30) Foreign Application Priority Data
Aug. 3, 2021 (JP) 2021-127686

(51) Int. Cl. G06N 20/00

(52) U.S. Cl. CPC G06N 20/00

(57) ABSTRACT

A behavioral change promotion device is a behavioral change promotion device for prompting each predetermined target user to perform a behavioral change and includes: a calculation unit configured continuance to calculate a degree of indicating continuance/discontinuance and a behavior change effect indicating an effect when a behavioral change is performed of each of a plurality of predetermined behavioral change types based on user information (first user information) including features of the target users for each target user; a selection unit configured to select a behavioral change type to be presented to a user out of the plurality of behavioral change types based on the degree of continuance and the behavioral change effect calculated by the calculation unit for each target user; and a promotion unit configured to promote a behavioral change for each user based on the behavioral change type to be presented to the user selected by the selection unit.

### TECHNICAL FIELD

An aspect of the present invention relates to a behavioral change promotion device.

### BACKGROUND ART

In the related art, techniques of prompting a user to execute an effective behavioral change by analyzing a state of each user based on user information and presenting advice information based on the result of analysis to the user for the purpose of change to an appropriate state are known (for example, Patent Literature 1 and Patent Literature 2).

### CITATION LIST

### Patent Literature

[Patent Literature 1] Japanese Unexamined Patent Publication No. 2011-14037

[Patent Literature 2] Japanese Unexamined Patent Publication No. 2008-238831

### SUMMARY OF INVENTION

### Technical Problem

However, in the aforementioned techniques, living conditions or behavioral habits of individual users are not considered sufficiently, and it cannot be said that an appropriate behavioral change which can be performed by users and which can be easily continuously performed has been promoted.

The present invention was made in consideration of the aforementioned circumstances and an objective thereof is to promote an appropriate behavioral change for each user.

### Solution to Problem

A behavioral change promotion device according to an aspect of the present invention is a behavioral change promotion device for prompting each predetermined target user to perform a behavioral change, the behavioral change promotion device including: a calculation unit configured to calculate a degree of continuance indicating continuance/discontinuance and a behavior change effect indicating an effect when a behavioral change is performed for each of a plurality of predetermined behavioral change types based on first user information including features of the target user for each target user; a selection unit configured to select a behavioral change type to be presented to a user out of the plurality of behavioral change types based on the degree of continuance and the behavioral change effect calculated by the calculation unit for each target user; and a promotion unit configured to promote a behavioral change for each user based on the behavioral change type to be presented to the user selected by the selection unit.

In the behavioral change promotion device according to the aspect of the present invention, a degree of continuance indicating continuance/discontinuance of each of a plurality of predetermined behavioral change types and a behavior change effect is calculated based on the first user information for each target user, a behavioral change type for each target user is selected based on the result of calculation, and a behavioral change for the selected behavioral change type is promoted. In this way, by deriving the degree of continuance and the behavioral change effect of each behavioral change type from information of each individual user (for example, living conditions or behavioral habits of individual users) and promoting a behavioral change for each user based on the result of derivation in this way, it is possible to promote a behavioral change with high continuance and with excellent effects on each user. That is, with the behavioral change promotion device according to the aspect of the present invention, it is possible to promote an appropriate behavioral change for each user.

### Advantageous Effects of Invention

According to the present invention, it is possible to promote an appropriate behavioral change for each user.

### BRIEF DESCRIPTION OF DRAWINGS

FIG. 1 is a functional block diagram illustrating a behavioral change promotion device according to an embodiment.

FIG. 2(a) is a diagram illustrating an example of user information and FIG. 2(b) is a diagram illustrating an example of achievement degree information.

FIG. 3(a) is a diagram illustrating an example of behavioral change condition information and FIG. 3(b) is a diagram illustrating an example of behavioral change details information.

FIG. 4 is a diagram illustrating an execution degree calculating process.

FIG. 5 is a diagram illustrating an execution degree estimation model constructing process.

FIG. 6 is a diagram illustrating the execution degree calculating process using the execution degree estimation model.

FIG. 7 is a diagram illustrating a continuance degree calculating process.

FIG. 8 is a diagram illustrating a continuance degree estimation model constructing process.

FIG. 9 is a diagram illustrating the continuance degree calculating process using the continuance degree estimation model.

FIG. 10 is a diagram illustrating a behavioral change execution/non-execution information calculating process.

FIG. 11 is a diagram illustrating a behavioral change effect estimation model constructing process.

FIG. 12 is a diagram illustrating a behavioral change effect calculating process.

FIG. 13(a) is a diagram illustrating an example of behavioral change index information, FIG. 13(b) is a diagram illustrating an example of behavioral change selection information, and FIG. 13(c) is a diagram illustrating an example of behavioral change promotion master information.

FIG. 14 is a flowchart illustrating a routine of processes which are performed by the behavioral change promotion device according to the embodiment.

FIG. 15 is a diagram illustrating a hardware configuration of the behavioral change promotion device according to the embodiment.

FIG. 16(a) is a diagram illustrating an example of behavioral change condition information according to a modified example and FIG. 3(b) is a diagram illustrating an example of behavioral change promotion master information according to a modified example.

FIG. 17 is a diagram illustrating an example of behavioral change promotion master information or the like according to a modified example.

### DESCRIPTION OF EMBODIMENTS

Hereinafter, an embodiment of the present invention will be described in detail with reference to the accompanying drawings. In description with reference to the drawings, the same or equivalent elements will be referred to by the same reference signs and repeated description thereof will be omitted.

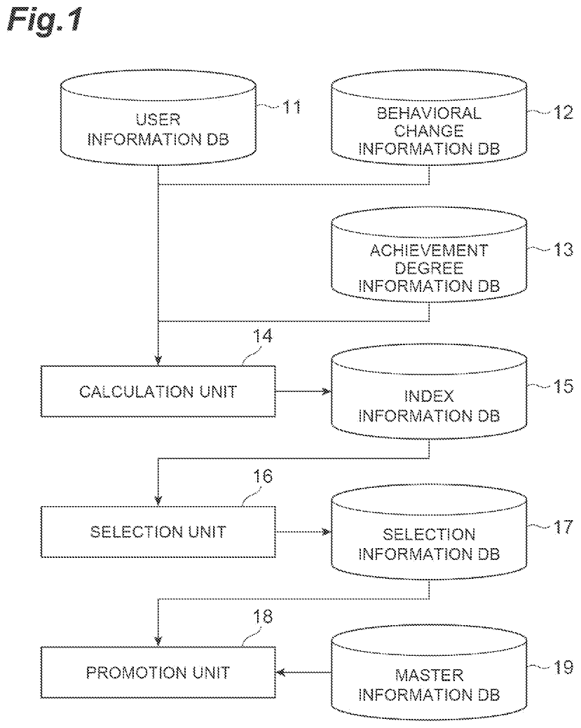

FIG. 1 is a functional block diagram of a behavioral change promotion device 1 according to an embodiment. The behavioral change promotion device 1 is a device that prompts a predetermined user to perform a behavioral change for reducing a risk in an unexpected event. The behavioral change promotion device 1 according to the embodiment presents a user with, for example, information for reducing a risk of an accident in driving which is an unexpected event for a user driving a vehicle (that is, a driver). Examples of a risk of an accident include occurrence/non-occurrence of an accident, an occurrence frequency of accidents, and a magnitude of damage when an accident occurs. In the following description, it is assumed that the “risk of an accident” is “accident occurrence/nonoccurrence.” The behavioral change promotion device 1 is provided to communicate with, for example, a communication device (a controller) of a vehicle which is driven by each user and transmits (presents) information for reducing a risk to a communication device of a vehicle which is driven by each user. For example, the behavioral change promotion device 1 may transmit (present) information for reducing a risk to a terminal such as a smartphone carried by each user through mails or the like.

As illustrated in FIG. 1, the behavioral change promotion device 1 includes a user information DB 11, a behavioral change information DB 12, an achievement degree information DB 13, a calculation unit 14, an index information DB 15, a selection unit 16, a selection information DB 17, a promotion unit 18, and a master information DB 19.

The user information DB 11 is a database in which user information (first user information) including features of each predetermined target user is stored. A target user is a user who is prompted to execute a behavioral change. The user information is information indicating features of each user including living conditions or behavioral habits of individual users which are calculated from attribute information, position information, purchase information, service use information, and the like and includes at least a person identifier as a key. The user information may roughly include mobility data and non-mobility data. The mobility data is data of a user associated with driving. The non-mobility data is data of a user not directly associated with driving such as attribute information and behavioral habits of the user. The mobility data is collected from, for example, sensors accessory to a vehicle, a drive recorder, or questionnaire information. The non-mobility data is collected from, for example, an information device owned by a user, a service use log, or questionnaire information.

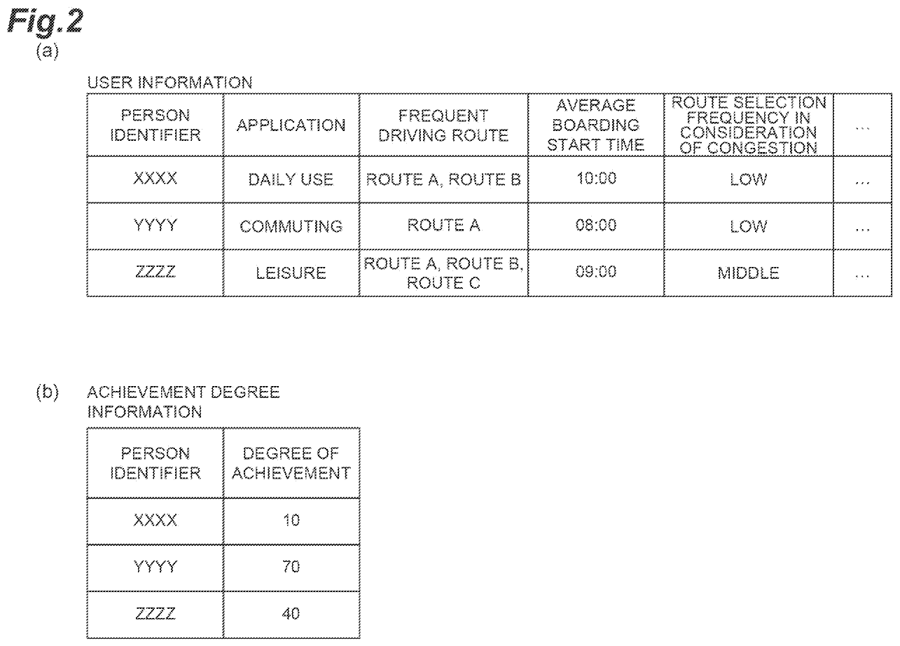

FIG. 2(a) is a diagram illustrating an example of user information (first user information) stored in the user information DB 11. In the example illustrated in FIG. 2(a), as user information, a person identifier for uniquely identifying a user, an application, a frequent driving route, an average boarding start time, and a route selection frequency in consideration of congestion are stored in correlation with each other. The user information is mobility data except for the person identifier. In the example illustrated in the uppermost part of FIG. 2(a), the application of a user (the usage of a vehicle) indicated by a person identifier “XXXX” is “daily use,” the frequent driving route is “route A and route B.” the average boarding start time is “10:00,” and the route selection frequency in consideration of congestion is “low.”

The achievement degree information DB 13 is a database in which a degree of achievement for each predetermined target user is stored. The degree of achievement is an index indicating a degree of attainment of a target state through a behavioral change and indicating a degree of attainment of details associated with reduction of an accident risk, for example, when the target state is “reduction of an accident risk in driving a vehicle.” In this case, the degree of achievement may be calculated, for example, based on a sudden braking frequency acquired from sensors accessory to a vehicle, increase as the sudden braking frequency decreases, and be maximized when the sudden braking frequency is 0.

FIG. 2(b) is a diagram illustrating an example of achievement degree information stored in the achievement degree information DB 13. As illustrated in FIG. 2(b), achievement degree information uses at least a person identifier as a key. In the example illustrated in FIG. 2(b), a person identifier and a degree of achievement are correlated with each other as achievement degree information. In the example illustrated in the uppermost part of FIG. 2(b), the degree of achievement of a user indicated by the person identifier “XXXX” is “10.”

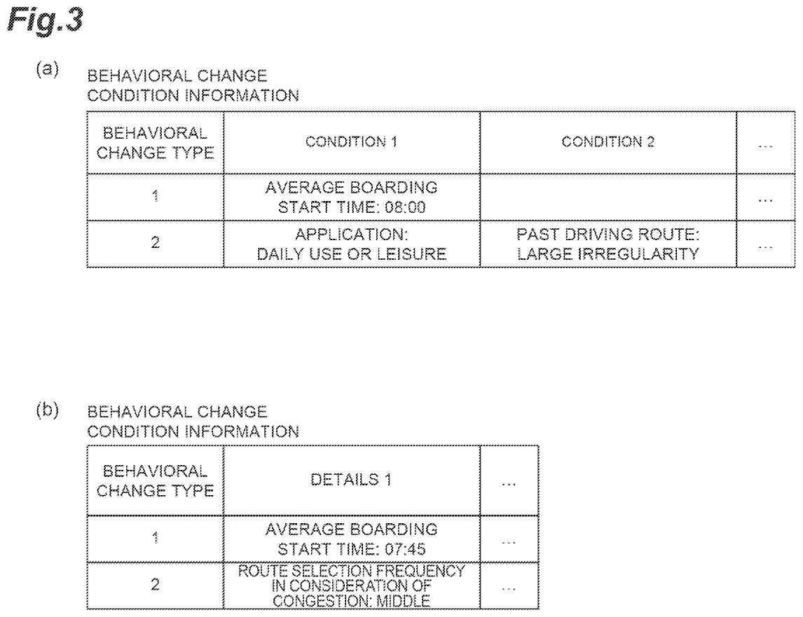

The behavioral change information DB 12 is a database in which behavioral change condition information and behavioral change details information defined in advance are stored. The behavioral change condition information is information for defining conditions for executing each predetermined behavioral change. FIG. 3(a) is a diagram illustrating an example of behavioral change condition information. In the example illustrated in FIG. 3(a), conditions for performing behavioral changes are defined using a behavioral change type as a key. In the example in the upper part of FIG. 3(a), the condition for executing a behavioral change of a behavioral change type “1” is defined as being “average boarding start time: 08:00” (condition 1). In the example illustrated in the lower part of FIG. 3(a), the condition for executing a behavioral change of a behavioral change type “2” is defined as being “application: daily use or leisure” (condition 1) and “past driving route: large irregularity” (condition 2). This behavioral change condition information is defined for each behavioral change type in consideration of a “possible value of user information of a user who can execute a behavioral change.”

The behavioral change details information is information for defining execution details of each predetermined behavioral change (specific behavior details). FIG. 3(b) is a diagram illustrating an example of behavioral change details information. In the example illustrated in FIG. 3(b), details of behavioral changes are defined using a behavioral change type as a key. In the example illustrated in the upper part of FIG. 3(b), details of a behavioral change of a behavioral change “1” are defined as being “boarding start time: 07:45.” In the example illustrated in the lower part of FIG. 3(b), details of a behavioral change of a behavioral change type “2” is defined as being “route selection frequency in consideration of congestion: middle.”

The calculation unit 14 calculates indices associated with behavioral change promotion for each of a plurality of predetermined behavioral change types based on the user information (first user information) or the like for each target user. The indices associated with behavioral change promotion include a degree of execution, a degree of continuance, and a behavioral change effect. Calculation of the indices which is performed by the calculation unit 14 will be described below in detail.

The calculation unit 14 calculates a degree of execution indicating execution/non-execution of each of the plurality of behavioral change types based on the user information for each target user. For example, the calculation unit 14 may determine whether behavior details of a user indicated by the user information satisfy execution conditions for behavior details associated with a plurality of behavioral change types, that is, conditions for executing a behavioral change indicated by the behavioral change condition information, for each target user and calculate a degree of execution of each of the plurality of behavioral change types based on a degree of satisfaction.

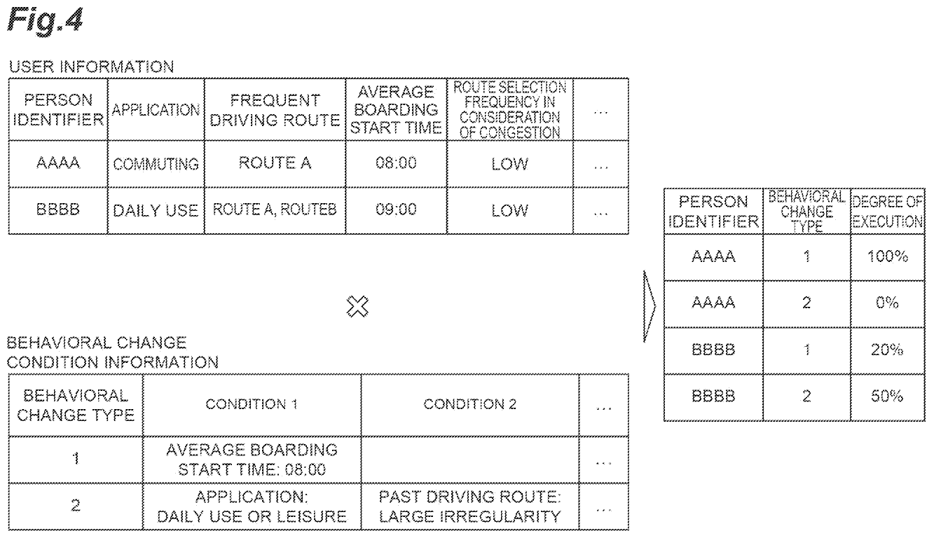

FIG. 4 is a diagram illustrating an execution degree calculating process. As illustrated in FIG. 4, it is assumed that information of a user indicated by a person identifier “AAAA” and a user indicated by a person identifier “BBBB” is defined as the user information. It is also assumed that execution conditions of a behavioral change of a behavioral change type “1” and a behavioral change of a behavioral change type “2” are defined as the behavioral change condition information. Specifically, it is assumed that the execution condition of the behavioral change of a behavioral change type “1” is “average boarding start time: 08:00” (condition 1) and the execution condition of the behavioral change of a behavioral change type “2” is “application: daily use or leisure” (condition 1) and “past driving route: large irregularity” (condition 2).

In this case, the calculation unit 14 determines that the user indicated by a person identifier “AAAA” satisfies condition 1 of the behavioral change type “1” because the average boarding start time is 08:00, and calculates the degree of execution of the behavioral change type “1” to be 100%. On the other hand, the calculation unit 14 determines that the user indicated by a person identifier “AAAA” does not satisfy both conditions 1 and 2 of the behavioral change type “2” because the application of a vehicle is commuting and the frequent driving route is not much different from route A, and calculates the degree of execution of the behavioral change type “2” to be 0%. In addition, the calculation unit 14 determines that a degree of satisfaction of condition 1 of the behavioral change type “1” by the user indicated by a person identifier “BBBB” is low because the average boarding start time is 09:00 (the degree of satisfaction is low because a difference in time therebetween is 1 hour), and calculates the degree of execution of the behavioral change type “1” to be 20%. On the other hand, the calculation unit 14 determines that the user indicated by a person identifier “BBBB” satisfies condition 1 of the behavioral change type “2” because the application of a vehicle is daily use but does not satisfy condition 2 of the behavioral change type “2” because the frequent driving route includes route A and route B and a difference in driving route therebetween is not large, and calculates the degree of execution of the behavioral change type “2” to be 50%. As described above, the calculation unit 14 may calculate the degree of execution to be 100% when all the conditions are satisfied and calculate the degree of execution to be a value corresponding to the degree of satisfaction of the conditions (for example, 50%) when only some specific conditions are satisfied.

The calculation unit 14 may construct a model for estimating a degree of execution (an execution degree estimation model) by learning training data and calculate the degree of execution based on the execution degree estimation model. That is, the calculation unit 14 may construct the execution degree estimation model for estimating a degree of execution by learning training user information (second user information) including features of each training user and information indicating execution/non-execution of each of the plurality of behavioral change types for each training user in correlation with each training user and calculate the degree of execution of each of the plurality of behavioral change types for each target user by inputting user information (first user information) including features of each target user to the execution degree estimation model.

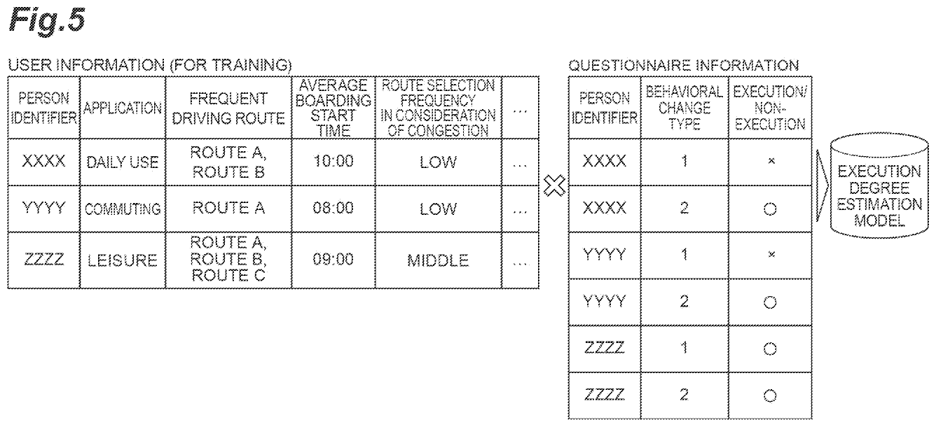

FIG. 5 is a diagram illustrating an execution degree estimation model constructing process. The user information illustrated in FIG. 5 is training user information (second user information). In the example illustrated in FIG. 5, similarly to the user information of each target user illustrated in FIG. 2(a), a person identifier for uniquely identifying a user, an application, a frequent driving route, an average boarding start time, and a route selection frequency in consideration of congestion are correlated in the training user information. The training user information is stored in the user information DB 11. Questionnaire information illustrated in FIG. 5 is information indicating questionnaire results collected from the training users and execution/non-execution of each behavioral change. Based on the premise that such questionnaire information is collected in advance, the calculation unit 14 constructs an execution degree estimation model by training the training user information and the questionnaire information (information on execution/non-execution of each of the plurality of behavioral change types for each training user) in correlation with each training user. Such a trained model (the execution degree estimation model) may be constructed, for example, using an existing statistical technique or machine learning technique (such as logistic regression, gradient-boosting decision tree, or neural networks). For example, the trained model may be constructed using a binary classification model when the execution/non-execution is stored as the execution/non-execution information and using a regression model when the execution/non-execution is stored as numerical information. A plurality of trained models may be constructed for each behavioral change type. The trained model may be constructed at an arbitrary timing, or may be replaced with a new trained model at a timing at which the new trained model has been constructed when the trained model was constructed in the past.

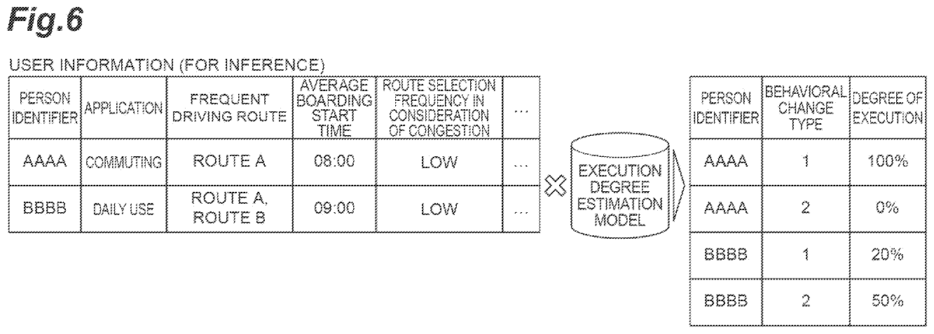

FIG. 6 is a diagram illustrating an execution degree calculating process using the execution degree estimation model. In the example illustrated in FIG. 6, the degrees of execution of a behavioral change type “1” and a behavioral change type “2” are calculated for each of two users indicated by the person identifiers “AAAA” and “BBBB” by inputting user information of two users indicated by the person identifiers “AAAA” and “BBBB” to the execution degree estimation model.

The behavioral change promotion device 1 may not calculate the degree of execution but may calculate only a degree of continuance and a behavioral change effect which will be described later. In this case, the behavioral change promotion device 1 may determine a mode of behavioral change promotion to be presented to a user based on the degree of continuance and the behavioral change effect.

The calculation unit 14 calculates a degree of continuance indicating continuance/non-continuance of each of the plurality of behavioral change types based on the user information for each target user. The calculation unit 14 may compare behavior details indicated by the user information (the first user information) with behavior details of the plurality of behavioral change types, that is, behavior details indicated by the behavioral change details information, and increase the degree of continuance for a behavioral change type with a smaller difference in behavior details therebetween for each target user.

This is based on an idea that it is difficult to continue to perform behavior of the user after a behavioral change has been performed because it is necessary to more change up-to-now behavior of the user as the difference becomes larger and it is easy to continue to perform behavior after a behavioral change has been performed because up-to-now behavior of the user do not change more as the difference becomes smaller. For example, a behavioral change of “depart from home earlier” is considered. For example, it is assumed that an average departure time of the corresponding user is 08:00 based on user information for recent several months. When there are behavioral change A “please depart at 07:45” and behavioral change B “please depart at 07:30,” it is considered that behavioral change A with which behavior does not need to be much changed is more easily continued for a user whose a departure time is 08:00. In this case, since a difference between behavioral change A and the average departure time is 15 minutes and a difference between behavioral change B and the average departure time is 30 minutes, the calculation unit 14 calculates a degree of continuance based on a predetermined rule based on these differences. The calculation unit 14 may calculate the degree of continuance, for example, such that the degree of continuance approaches 100% as the difference approaches 0 and the degree of continuance becomes 0% as the difference becomes equal to or greater than a specific threshold value.

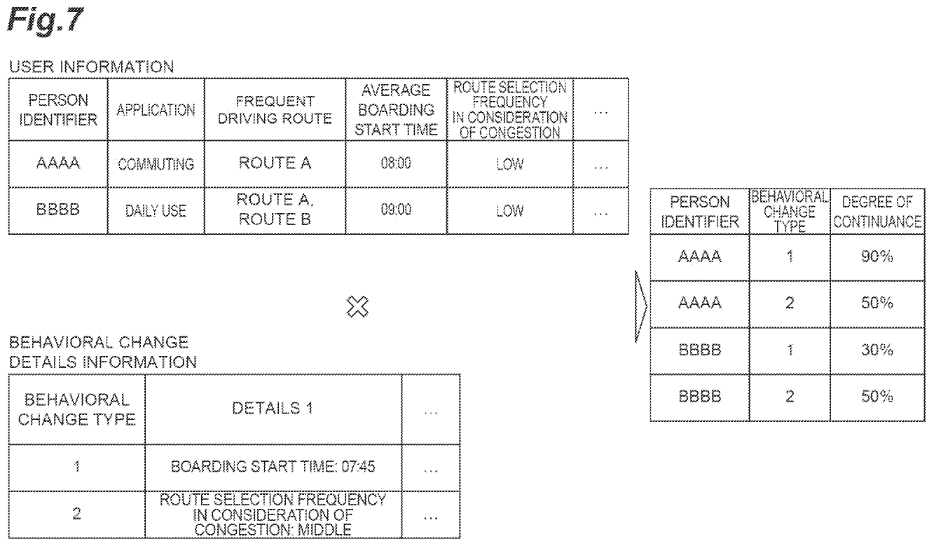

FIG. 7 is a diagram illustrating the continuance degree calculating process. As illustrated in FIG. 7, it is assumed that information of a user indicated by a person identifier “AAAA” and a user indicated by a person identifier “BBBB” is defined as the user information. It is assumed that behavior details of a behavioral change of a behavioral change type “1” and a behavioral change of a behavioral change type “2” are defined as the behavioral change details information. Specifically, it is assumed that behavior details of the behavioral change of the behavioral change type “1” are “boarding start time: 07:45” and behavior details of the behavioral change of the behavioral change type “2” are “route selection frequency in consideration of congestion: middle.”

In this case, the calculation unit 14 determines that a difference from the behavior details “boarding start time: 07:45” of the behavioral change type “1” is relatively small because the average boarding start time of the user indicated by a person identifier “AAAA” is 08:00 and calculates the degree of continuance of the behavioral change type “1” to be 90%. On the other hand, the calculation unit 14 determines that a difference from the behavior details “route selection frequency in consideration of congestion: middle” of the behavioral change type “2” is about middle because the route selection frequency in consideration of congestion of the user indicated by a person identifier “AAAA” is low and calculates the degree of continuance of the behavioral change type “2” to be 50%. The calculation unit 14 determines that a difference from the behavior details “boarding start time: 07:45” of the behavioral change type “1” is relatively large because the average boarding start time of the user indicated by a person identifier “BBBB” is 09:00 and calculates the degree of continuance of the behavioral change type “1” to be 30%. On the other hand, the calculation unit 14 determines that a difference from the behavior details “route selection frequency in consideration of congestion: middle” of the behavioral change type “2” is about middle because the route selection frequency in consideration of congestion of the user indicated by a person identifier “BBBB” is low and calculates the degree of continuance of the behavioral change type “2” to be 50%. In calculating the degree of continuance, a predetermined difference may be permitted for comparison between the user information and the behavioral change details information. For example, when the behavior details indicated by the behavioral change details information is “boarding start time: 07:45” and “average boarding start time: 07:50” is defined in the user information, a difference of 5 minutes occurs in the behavior details, and thus the calculation unit 14 may determine that the difference is small and calculate the degree of continuance to be 100%.

The calculation unit 14 may identify habitual behavior details which are habituated behavior details by collecting behavior details indicated by the user information collected for a predetermined period for each target user, compare the habitual behavior details with the behavior details of the plurality of behavioral change types, and calculate the degree of continuance to be higher as the difference in behavior details of the corresponding behavioral change type becomes smaller. Specifically, for example, an average “boarding start time” is calculated from “boarding start times” for recent several months, and the average “boarding start time” is identified as habitual behavior details.

When one behavioral change includes a plurality of behavior details, the calculation unit 14 may calculate the whole degree of continuance based on the degrees of continuance of the behavior details. For example, behavior details “depart from home earlier (first behavior details) and select a route for avoiding a congested route (second behavior details)” are considered. In this case, it is assumed that the degrees of continuance of two behavior details are calculated to be 80% and 60% from a difference between current behavior details or habitual behavior details of a user and the two behavior details included in a behavioral change. In this case, the calculation unit 14 may calculate the whole degree of continuance to be 48% by multiplying the two degrees of continuance. The calculation unit 14 may calculate the whole degree of continuance of the behavioral change to be 80% by employing the larger degree of continuance. The calculation unit 14 may calculate the whole degree of continuance of the behavioral change from three or more behavior details included in the behavioral change.

The calculation unit 14 may calculate the degree of continuance repeatedly at intervals of a predetermined time. In this case, the calculation unit 14 may calculate the degree of continuance using new user information in a time series. When the degree of continuance is repeatedly calculated, the calculation unit 14 may output the newest degree of continuance. Accordingly, the newest degree of continuance is used for subsequent processes.

For example, it is conceivable that behavioral change promotion “please depart at 07:45” be continuously performed on a user whose the average departure time is 08:00 based on the user information for recent several months and thus the average departure time be changed to 07:45 as a result when the average departure time is calculated from the user information for recent several months after the several months has elapsed. At this time, with the behavioral change promotion “please depart at 07:30,” the difference when the average departure time has become 07:45 is smaller than that when the average departure time is 08:00, and the degree of continuance is calculated to be larger. In this way, by repeatedly calculating the degree of continuance, it is possible to more appropriately calculate the degree of continuance in consideration of change in habit of a user with the elapse of time.

The calculation unit 14 may construct a model for estimating a degree of continuance (a continuance degree estimation model) by learning training data and calculate the degree of continuance based on the continuance degree estimation model. That is, the calculation unit 14 may construct the continuance degree estimation model for calculating a degree of continuance by learning training user information (second user information) including features of each training user and information indicating continuance/discontinuance of each of the plurality of behavioral change types for each training user in correlation with the corresponding training users and calculate the degree of continuance of each of the plurality of behavioral change types for each target user by inputting the user information including features of each target user (first user information) to the continuance degree estimation model.

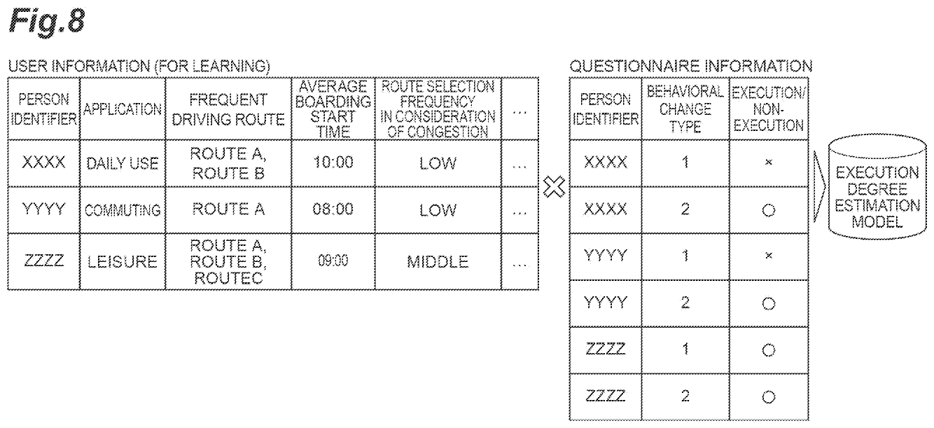

FIG. 8 is a diagram illustrating a continuance degree estimation model constructing process. The user information illustrated in FIG. 8 is training user information (second user information). In the example illustrated in FIG. 8, similarly to the user information of each target user illustrated in FIG. 2(a), a person identifier for uniquely identifying a user, an application, a frequent driving route, an average boarding start time, and a route selection frequency in consideration of congestion are correlated in the training user information. The training user information is stored in the user information DB 11. Questionnaire information illustrated in FIG. 8 is information indicating questionnaire results collected from the training users and continuance/discontinuance of each behavioral change. Based on the premise that such questionnaire information is collected in advance, the calculation unit 14 constructs a continuance degree estimation model by training the training user information and the questionnaire information (information on continuance/discontinuance of each of the plurality of behavioral change types for each training user) in correlation with each training user. Such a trained model (the execution degree estimation model) may be constructed, for example, using an existing statistical technique or machine learning technique (such as logistic regression, gradient-boosting decision tree, or neural networks). For example, the trained model may be constructed using a binary classification model when the continuance/discontinuance is stored as the execution/non-execution information and using a regression model when the continuance/discontinuance is stored as numerical information. A plurality of trained models may be constructed for each behavioral change type. The trained model may be constructed at an arbitrary timing, or may be replaced with a new trained model at a timing at which the new trained model has been constructed when the trained model was constructed in the past.

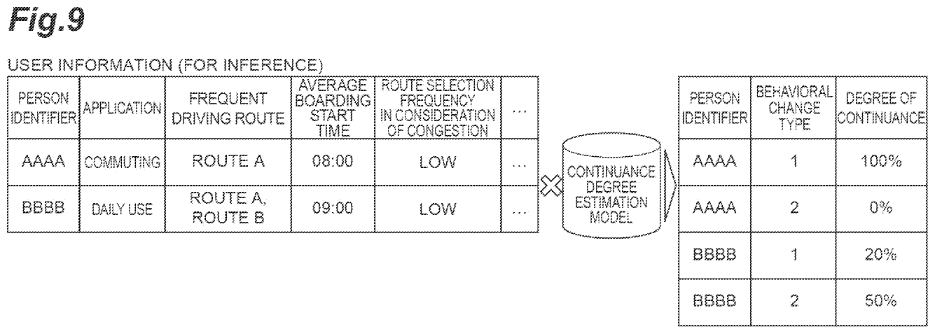

FIG. 9 is a diagram illustrating the continuance degree calculating process using the continuance degree estimation model. In the example illustrated in FIG. 9, the degrees of continuance of a behavioral change type “1” and a behavioral change type “2” are calculated for each of two users indicated by the person identifiers “AAAA” and “BBBB” by inputting user information of users indicated by the person identifiers “AAAA” and “BBBB” to the continuance degree estimation model.

The calculation unit 14 calculates a behavioral change effect when each of the plurality of behavioral change types is performed based on the user information for each target user. As a process for calculating the behavioral change effects, the calculation unit 14 performs, for example, a behavioral change execution/non-execution calculating process, a behavioral change effect estimation model constructing process, and a behavioral change effect calculating process.

In the behavioral change execution/non-execution calculating process, the calculation unit 14 generates behavioral change execution/non-execution information indicating a probability level as behavior details of each training user for each of the plurality of behavioral change types by comparing behavior details of a user indicated by user information including features of each training user (second user information) with behavior details associated with the plurality of behavioral change types. Specifically, the calculation unit 14 sets the behavioral change execution/non-execution of the corresponding behavioral change type to “YES” when behavior details associated with each behavioral change type indicated by the behavioral change details information are included in the user information and sets the behavioral change execution/non-execution of the corresponding behavioral change type to “NO” when the behavior details are not included.

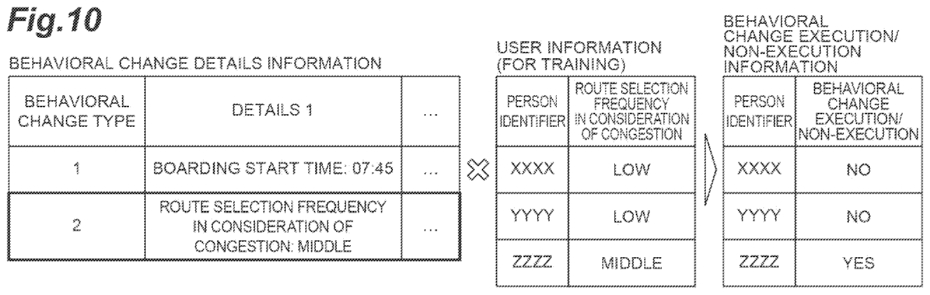

FIG. 10 is a diagram illustrating the behavioral change execution/non-execution information calculating process. In the example illustrated in FIG. 10, it is determined whether the behavior details “route selection frequency in consideration of congestion: middle” of the behavioral change of the behavioral change type “2” indicated by the behavioral change details information is included in behavior details of each user indicated by the user information, the behavioral change execution/non-execution of users indicated by person identifiers “XXXX” and “YYYY” not included in the user information is set to “NO.” and the behavioral change execution/non-execution of a user indicated by a person identifier “ZZZZ” included in the user information is set to “YES.” In calculating the behavioral change execution/non-execution information, a predetermined difference may be permitted for comparison between the behavioral change details information and the user information. For example, when the behavior details indicated by the behavioral change details information are “boarding start time: 07:45” and the user information indicates “average boarding start time: 07:50,” there is a difference of 5 minutes in the behavior details, but the difference may be determined to be small and the behavioral change execution/non-execution may be considered to be “YES.”

In the behavioral change effect estimation model constructing process which is performed subsequent to the behavioral change execution/non-execution calculating process, the calculation unit 14 constructs a behavioral change effect estimation model for calculating a behavioral change effect by training the user information (second user information), the behavioral change execution/non-execution information of each of the plurality of behavioral change types, and the degree of achievement for a target state through a behavioral change in correlation with each training user.

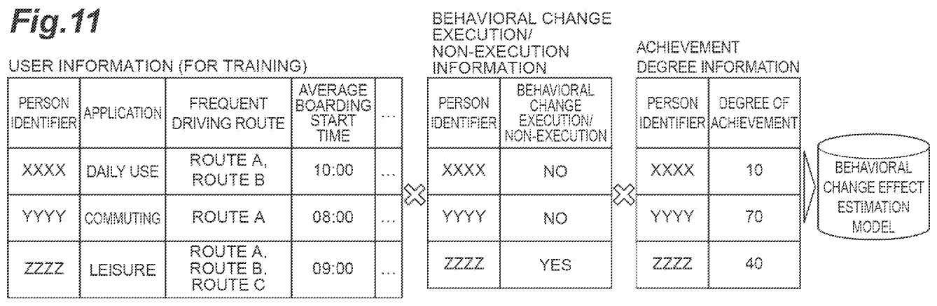

FIG. 11 is a diagram illustrating the behavioral change effect estimation model constructing process. The user information illustrated in FIG. 11 is training user information (second user information). In the example illustrated in FIG. 11, similarly to the user information of each target user illustrated in FIG. 2(a), a person identifier for uniquely identifying a user, an application, a frequent driving route, and an average boarding start time are correlated in the training user information. The training user information is stored in the user information DB 11. The behavioral change execution/non-execution information illustrated in FIG. 11 is information which is calculated (generated) through the behavioral change execution/non-execution calculating process and indicates behavioral change execution/non-execution of behavior details “route selection frequency in consideration of congestion: middle” of the behavioral change of the behavioral change type “2” indicated by the behavioral change details information of FIG. 10. The achievement degree information illustrated in FIG. 11 is information stored in the achievement degree information DB 13. The calculation unit 14 constructs a behavioral change effect estimation model by training the training user information, the behavioral change execution/non-execution information, and the achievement degree information in correlation with each training user. Such a trained model (the behavioral change effect estimation model) may be constructed, for example, using an existing causal inference technique. A plurality of behavioral change effect estimation models may be constructed for each behavioral change type. The trained model may be constructed at an arbitrary timing, or may be replaced with a new trained model at a timing at which the new trained model has been constructed when the trained model was constructed in the past.

In the behavioral change effect calculating process, the calculation unit 14 calculates a behavioral change effect of each of the plurality of behavioral change types by inputting the user information (first user information) including features of each target user to the behavioral change effect estimation model. The behavioral change effect which is output from the behavioral change effect estimation model indicates an a degree of achievement which changes by causing a predetermined user to execute a predetermined behavioral change.

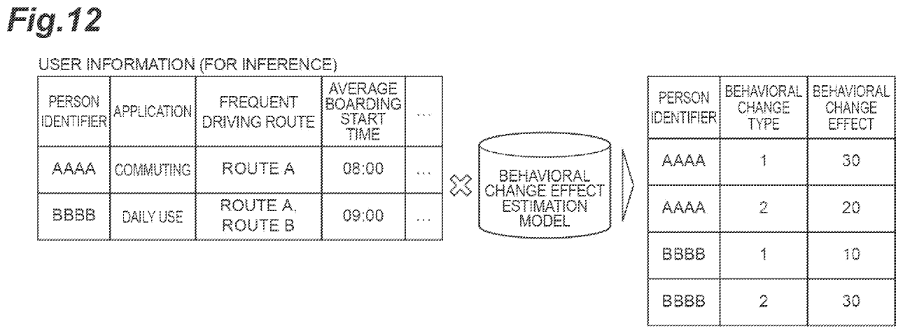

FIG. 12 is a diagram illustrating the behavioral change effect calculating process. In the example illustrated in FIG. 12, behavioral change effects of the behavioral change type “1” and the behavioral change type “2” for each of two users indicated by the person identifiers “AAAA” and “BBBB” are calculated by inputting user information of the two users indicated by the person identifiers “AAAA” and “BBBB” to the behavioral change effect estimation model. For example, in the example illustrated in FIG. 12, when the user indicated by the person identifier “AAAA” has executed the behavioral change of the behavioral change type “1,” the degree of achievement may increase by 30 (may approach a target state).

In calculating a behavioral change effect, the behavioral change effect estimation model may not have to be used, and an arbitrary causal inference technique that can derive a behavioral change effect based on a feature quantity affecting at least one of the degree of achievement and the behavioral change execution/non-execution information in addition to the degree of achievement and the behavioral change execution/non-execution information may be used. The feature quantity is information other than information indicating features used to calculate the behavioral change execution/non-execution information out of information indicating features included in the user information.

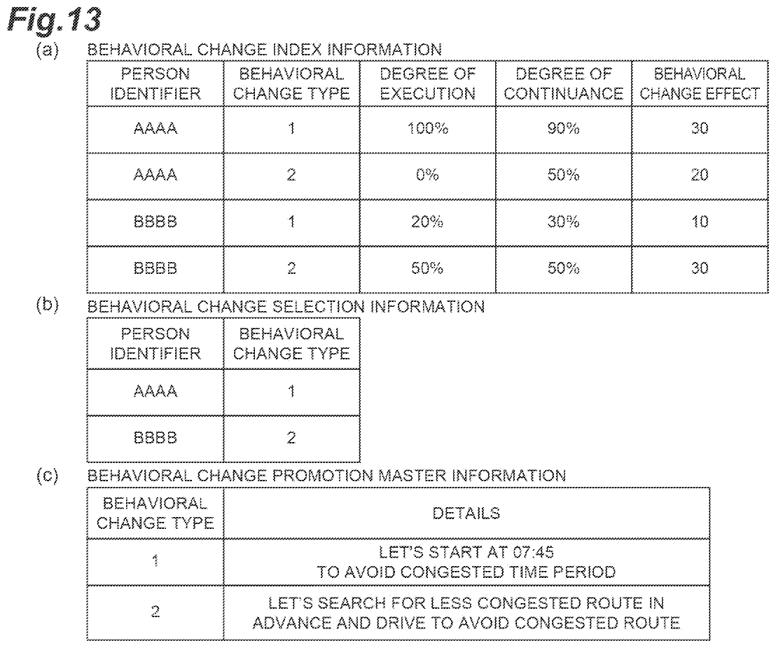

The calculation unit 14 derives the behavioral change index information by correlating a person identifier and a behavioral change type for each of the calculated indices (the degree of execution, the degree of continuance, and the behavioral change effect). FIG. 13(a) is a diagram illustrating an example of the behavioral change index information. As illustrated in FIG. 13(a), a person identifier, a behavioral change type, a degree of execution, a degree of continuance, and a behavioral change effect are correlated in the behavioral change index information. The calculation unit 14 stores the derived behavioral change index information in the index information DB 15 (see FIG. 1). The index information DB 15 stores the behavioral change index information.

Referring back to FIG. 1, the selection unit 16 selects a behavioral change type to be presented to a user out of the plurality of behavioral change types based on the information (that is, the behavioral change index information) derived by the calculation unit 14 for each target user. That is, the selection unit 16 selects a behavioral change type to be presented to a user based on the degree of execution, the degree of continuance, and the behavioral change effect calculated by the calculation unit 14 for each target user, with reference to the behavioral change index information stored in the index information DB 15.

The selection unit 16 may select a behavioral change type with a maximum product of the indices (the degree of execution, the degree of continuance, and the behavioral change effect) out of the plurality of behavioral change types. Specifically, when a behavioral change type to be presented to a user indicated by the person identifier “BBBB” is selected in the example of the behavioral change types illustrated in FIG. 13(a), the degree of execution (20%)×the degree of continuance (30%)×the behavioral change effect (10)=0.6 is calculated for the behavioral change type “1,” and the degree of execution (50%)×the degree of continuance (50%)×the behavioral change effect (30)=7.5 is calculated for the behavioral change type “2,” and thus the behavioral change type “2” is selected.

The selection unit 16 stores information of a behavioral change type selected for each target user as behavioral change selection information in the selection information DB 17. FIG. 13(b) is a diagram illustrating an example of the behavioral change selection information. As illustrated in FIG. 13(b), a person identifier and a selected behavioral change type are correlated in the behavioral change selection information. The selection information DB 17 stores the behavioral change selection information.

Referring back to FIG. 1, the promotion unit 18 performs promotion of a behavioral change for each target user based on the behavioral change type to be presented to a user selected by the selection unit 16. Specifically, the promotion unit 18 performs the behavioral change promotion for each target user based on the behavioral change selection information (see FIG. 13(b)) identified with reference to the selection information DB 17 and the behavioral change promotion master information (see FIG. 13(c)) identified with reference to the master information DB 19. FIG. 13(c) is a diagram illustrating an example of the behavioral change promotion master information. As illustrated in FIG. 13(c), a behavioral change type and behavioral change promotion details are correlated in the behavioral change promotion master information. For example, “Let's start at 07:45 to avoid a congested time period” is defined as the behavioral change promotion details of the behavioral change type “1,” and “let's search for a less congested route in advance and then drive to avoid a congested route” is defined as the behavioral change promotion details of the behavioral change type “2.”

The promotion unit 18 correlates the behavioral change selection information and the behavioral change promotion master information using the behavioral change type as a key and identifies the behavioral change promotion details associated with an appropriate behavioral change type for each target user. Then, the promotion unit 18 performs behavioral change promotion for each target user based on the identified behavioral change promotion details. The behavioral change promotion method may be an arbitrary method, and behavioral change promotion may be performed, for example, by sending a mail or the like to a terminal such as a smartphone carried by each target user.

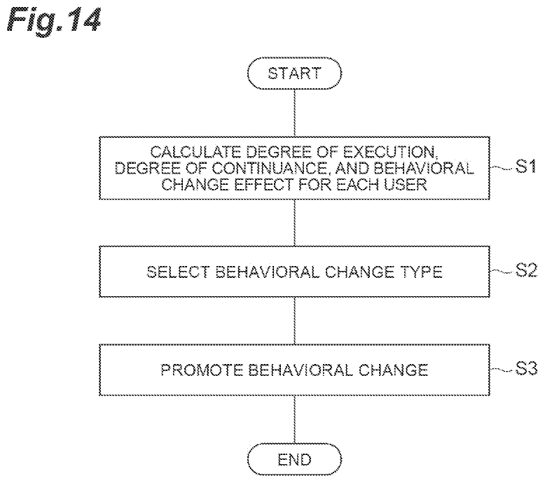

A behavioral change promoting process which is performed by the behavioral change promotion device 1 according to the embodiment will be described below with reference to FIG. 14.

FIG. 14 is a flowchart illustrating a behavioral change promoting process which is performed by the behavioral change promotion device 1. As illustrated in FIG. 14, in the behavioral change promoting process, first, a degree of execution, a degree of continuance, and a behavioral change effect of each of a plurality of predetermined behavioral change types are calculated based on user information (first user information) for each user (Step S1). Behavioral change index information is derived based on the calculated indices (the degree of execution, the degree of continuance, and the behavioral change effect), and the behavioral change index information is stored in the index information DB 15.

Subsequently, a behavioral change type to be presented to a user is selected out of the plurality of behavioral change types based on the behavioral change index information for each target user (Step S2). Behavioral change selection information is derived based on information of the selected behavioral change type, and the behavioral change selection information is stored in the selection information DB 17.

By correlating the behavioral change selection information and the behavioral change promotion master information using a behavioral change type as a key, details of the behavioral change promotion associated with an appropriate behavioral change type are identified for each target user and behavioral change promotion for each target user is performed (Step S3). The behavioral change promoting process is performed in this way.

Operations and advantages of the embodiment will be described below.

The behavioral change promotion device 1 according to the embodiment is a behavioral change promotion device for prompting each predetermined target user to perform a behavioral change and includes: a calculation unit 14 configured to calculate a degree of continuance indicating continuance/discontinuance and a behavior change effect indicating an effect when a behavioral change is performed of each of a plurality of predetermined behavioral change types based on user information (first user information) including features of the target users for each target user; a selection unit 16 configured to select a behavioral change type to be presented to a user out of the plurality of behavioral change types based on the degree of continuance and the behavioral change effect calculated by the calculation unit 14 for each target user; and a promotion unit 18 configured to promote a behavioral change for each user based on the behavioral change type to be presented to the user selected by the selection unit 16.

In the behavioral change promotion device 1 according to the embodiment, a degree of continuance indicating continuance/discontinuance of each of a plurality of predetermined behavioral change types and a behavior change effect are calculated based on the first user information for each target user, a behavioral change type for each target user is selected based on the result of calculation, and a behavioral change for the selected behavioral change type is promoted. In this way, by deriving the degree of continuance and the behavioral change effect of each behavioral change type from information of each individual user (for example, living conditions or behavioral habits of individual users) and promoting a behavioral change for each user based on the result of derivation in this way, it is possible to promote a behavioral change with high continuance and with excellent effects on each user. That is, with the behavioral change promotion device 1 according to the embodiment, it is possible to promote an appropriate behavioral change for each user. Since an appropriate behavioral change for each user can be promoted, it is possible to minimize the number of times of behavioral change promotion for each user and to curb a communication load.

The calculation unit 14 may compare behavior details associated with the plurality of behavior change types with behavior details indicated by the first user information for each target user and increase the degree of continuance for a behavioral change type with a smaller difference in behavior details. The behavioral change type with a smaller difference in behavior details is considered to be a behavioral change type which a user can easily continue to perform. Accordingly, by increasing the degree of continuance for a behavioral change type with a smaller difference in behavior details, a behavioral change type which a user can easily continue to perform can be more easily selected and thus it is possible to promote an appropriate behavioral change for each user.

The calculation unit 14 may identify habitual behavior details which are habituated behavior details by collecting the behavior details indicated by the first user information collected in a predetermined period, compare the behavior details associated with the plurality of behavioral change types with the habitual behavior details, and increase the degree of continuance for a behavioral change type with a smaller difference in behavior details for each target user. Since the degree of continuance is calculated from habitual behavior details of a user by identifying habitual behavior details from the user information in a predetermined period and calculating the degree of continuance based on the habitual behavior details, it is possible to enhance calculation accuracy of the degree of continuance and thus to promote an appropriate behavioral change for each user.

The calculation unit 14 may calculate the degree of continuance repeatedly at intervals of a predetermined time. By repeatedly calculating the degree of continuance in this way, it is possible to select appropriate behavioral change promotion according to change in habits of a user with the elapse of time.

The calculation unit 14 may construct a continuance degree estimation model for calculating the degree of continuance by learning second user information including features of each training user and information on continuance/discontinuance of each of the plurality of behavioral change types for each training user in correlation with the corresponding training user and calculate the degree of continuance of each of the plurality of behavioral change types for each target user by inputting the first user information to the continuance degree estimation model. By calculating the degree of continuance using the continuance degree estimation model constructed by learning the training user information in this way, it is possible to enhance calculation accuracy of the degree of continuance.

The calculation unit 14 may generate behavioral change execution/non-execution information indicating a probability level as behavior details of each training user for each of the plurality of behavioral change types by comparing behavior details of a user indicated by second user information including features of each training user with behavior details associated with the plurality of behavioral change types, construct a behavioral change effect estimation model for calculating the behavioral change effects by learning the second user information, the behavioral change execution/non-execution information for each of the plurality of behavioral change types, and a degree of achievement of a target state in the corresponding behavioral change in correlation with the corresponding training user, and calculate the behavioral change effect of each of the plurality of behavioral change types for each target user by inputting the first user information to the behavioral change effect estimation model. By calculating the behavioral change effect using the behavioral change effect estimation model constructed by learning the training user information in this way, it is possible to enhance calculation accuracy of a behavioral change effect.

The calculation unit 14 may additionally calculate a degree of execution indicating execution/non-execution of each of the plurality of behavioral change types based on the first user information for each target user, and the selection unit 16 may select the behavioral change type to be presented to a user based on the degree of continuance, the behavioral change effect, and the degree of execution calculated by the calculation unit 14. By selecting a behavioral change type in consideration of the degree of execution indicating execution/non-execution of a behavioral change in addition to the degree of continuance and the behavioral change effect in this way, it is possible to promote a more appropriate behavioral change for each user.

The calculation unit 14 may determine whether behavior details of a user indicated by the first user information satisfy execution conditions of the behavior details associated with the plurality of behavioral change types for each target user and calculate the degree of execution of each of the plurality of behavioral change types based on a degree of satisfaction. Accordingly, it is possible to more appropriately calculate the degree of execution.

The calculation unit 14 may construct an execution degree estimation model for calculating the degree of execution by learning second user information including features of each training user and information on execution/non-execution of each of the plurality of behavioral change types for each training user in correlation with the corresponding training user and calculate the degree of execution of each of the plurality of behavioral change types for each target user by inputting the first user information to the execution degree estimation model. By calculating the degree of execution using the execution degree estimation model constructed by learning the training user information in this way, it is possible to enhance calculation accuracy of the degree of execution.

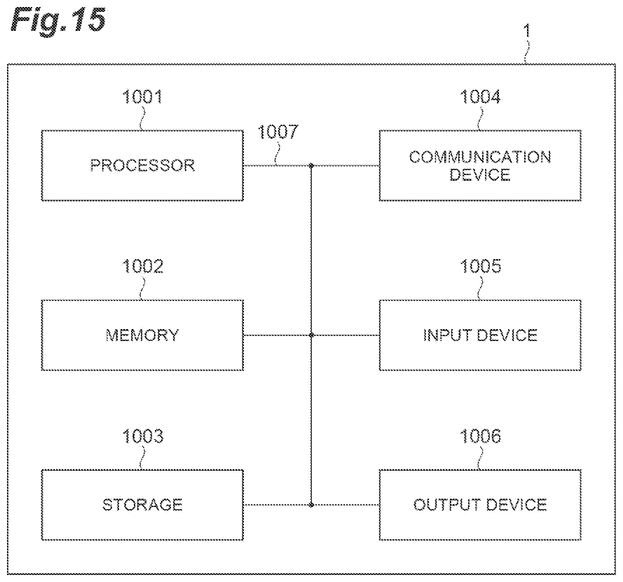

A hardware configuration of the behavioral change promotion device 1 will be described below with reference to FIG. 15. The behavioral change promotion device I may be physically configured as a computer device including a processor 1001, a memory 1002, a storage 1003, a communication device 1004, an input device 1005, an output device 1006, and a bus 1007.

In the following description, the term “device” can be replaced with circuit, device, unit, or the like. The hardware configuration of the behavioral change promotion device 1 may be configured to include one or more devices illustrated in the drawing or may be configured to exclude some devices thereof.

The functions of the behavioral change promotion device 1 can be realized by reading predetermined software (program) to hardware such as the processor 1001 and the memory 1002 and causing the processor 1001 to execute arithmetic operations and to control communication using the communication device 1004 or to control at least one of reading and writing of data with respect to the memory 1002 and the storage 1003.

The processor 1001 controls a computer as a whole, for example, by causing an operating system to operate. The processor 1001 may be configured as a central processing unit (CPU) including an interface with peripherals, a controller, an arithmetic operation unit, and a register. For example, the control functions such as the calculation unit 14 may be realized by the processor 1001.

The processor 1001 reads a program (a program code), a software module, data, or the like from at least one of the storage 1003 and the communication device 1004 to the memory 1002 and performs various processes in accordance therewith. As the program, a program that causes a computer to perform at least some of the operations described in the above-mentioned embodiment is used.

For example, the control functions such as the calculation unit 14 may be realized by a control program which is stored in the memory 1002 and which operates in the processor 1001, and the other functional blocks may be realized in the same way. The various processes described above are described as being performed by a single processor 1001, but they may be simultaneously or sequentially performed by two or more processors 1001. The processor 1001 may be mounted as one or more chips. The program may be transmitted from a network via an electrical telecommunication line.

The memory 1002 is a computer-readable recording medium and may be constituted by, for example, at least one of a read only memory (ROM), an erasable programmable ROM (EPROM), an electrically erasable programmable ROM (EEPROM), and a random access memory (RAM). The memory 1002 may be referred to as a register, a cache, a main memory (a main storage device), or the like. The memory 1002 can store a program (a program code), a software module, and the like that can be executed to perform a radio communication method according to an embodiment of the present disclosure.

The storage 1003 is a computer-readable storage medium and may be constituted by, for example, at least one of an optical disc such as a compact disc ROM (CD-ROM), a hard disk drive, a flexible disk, a magneto-optical disc (for example, a compact disc, a digital versatile disc, or a Blu-ray (registered trademark) disc), a smart card, a flash memory (for example, a card, a stick, or a key drive), a floppy (registered trademark) disk, and a magnetic strip. The storage 1003 may be referred to as an auxiliary storage device. The storage media may be, for example, a database, a server, or another appropriate medium including the memory 1002 and/or the storage 1003.

The communication device 1004 is hardware (a transmitting and receiving device) that performs communication between computers via at least one of a wired network and a wiresmaller network and is also referred to as, for example, a network device, a network controller, a network card, or a communication module.

The input device 1005 is an input device that receives an input from the outside (for example, a keyboard, a mouse, a microphone, a switch, a button, or a sensor). The output device 1006 is an output device that performs an output to the outside (for example, a display, a speaker, or an LED lamp). The input device 1005 and the output device 1006 may be configured as a unified body (for example, a touch panel).

The devices such as the processor 1001 and the memory 1002 are connected to each other via the bus 1007 for transmission of information. The bus 1007 may be constituted by a single bus or may be constituted by buses which are different depending on the devices.

The behavioral change promotion device 1 may be configured to include hardware such as a microprocessor, a digital signal processor (DSP), an application-specific integrated circuit (ASIC), a programmable logic device (PLD), or a field-programmable gate array (FPGA), and some or all of the functional blocks may be realized by the hardware. For example, the processor 1001 may be mounted using at least one piece of the hardware.

While the present disclosure has been described above in detail, it will be apparent to those skilled in the art that the present disclosure is not limited to the embodiments described in the present disclosure. The present disclosure can be altered and modified in various forms without departing from the gist and scope of the present disclosure defined by description in the appended claims. Accordingly, the description in the present disclosure is for exemplary explanation and does not have any restrictive meaning for the present disclosure.

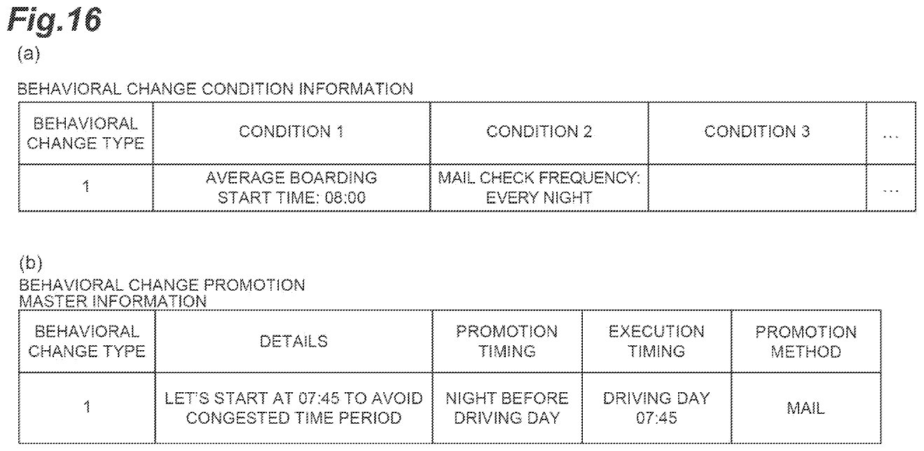

For example, as illustrated in FIG. 16(b), in the behavioral change promotion master information, a behavioral change promotion timing (for example, “night before driving day”), a behavioral change execution timing (for example, “07:45 of driving day”), and a behavioral change promotion method (for example, “mail”) may be defined in addition to behavioral change promotion details. In this case, for example, as illustrated in FIG. 16(a), a mail check frequency (for example, “every night”) may be defined in the behavioral change condition information. A degree of execution may be calculated in consideration of information such as the behavioral change promotion master information or the behavioral change condition information. Specifically, the degree of execution may be calculated by also comparing a mail check frequency included in the user information with “mail check frequency: every night” defined in the behavioral change condition information. The degree of execution may be calculated in consideration of a difference between the behavioral change promotion timing and the behavioral change execution timing defined in the behavioral change promotion master information. For example, behavioral change promotion is performed in the night before a driving day on a user who checks mails every night. In this case, since conditions described in the behavioral change condition information are satisfied and behavioral change is promoted in the night before a driving day, there is a time difference between the behavioral change promotion timing and a timing at which the behavioral change is actually executed (for example, 07:45 of the driving day) and thus it is conceivable that details of the behavioral change promotion be lost or not be accurately executed at the timing at which the behavioral change is actually executed. Accordingly, the calculation unit 14 performs comparison between the behavioral change promotion timing and the behavioral change execution timing defined in the behavioral change promotion master information in addition to comparison between the user information and the behavioral change condition information and sets the degree of execution of one behavioral change type calculated through comparison between the user information and the behavioral change condition information to be smaller as the temporal difference becomes larger.

When there is a less congested time between the behavioral change promotion timing and the timing at which the behavioral change is actually executed, it is conceivable that details of the behavioral change promotion be lost or not be accurately executed at the timing at which the behavioral change is actually executed. In this regard, by decreasing the degree of execution of a behavioral change type with a larger temporal difference between the behavioral change promotion timing and the behavioral change execution timing such that it is made difficult to select the behavioral change type, it is possible to select a behavioral change type with a higher likelihood of execution and to more appropriately promote a behavioral change for each user.

In the embodiment, the degree of achievement is a degree of achievement when “reduction of an accident risk in driving a vehicle” is a target state, but the present invention is not limited thereto. For example, the degree of achievement may be a degree of achievement when “being healthy” is a target state. In this case, the degree of achievement may be calculated from an amount of activity acquired from an activity meter or the like. Specifically, the degree of achievement may be calculated to increase as the amount of activity increases.

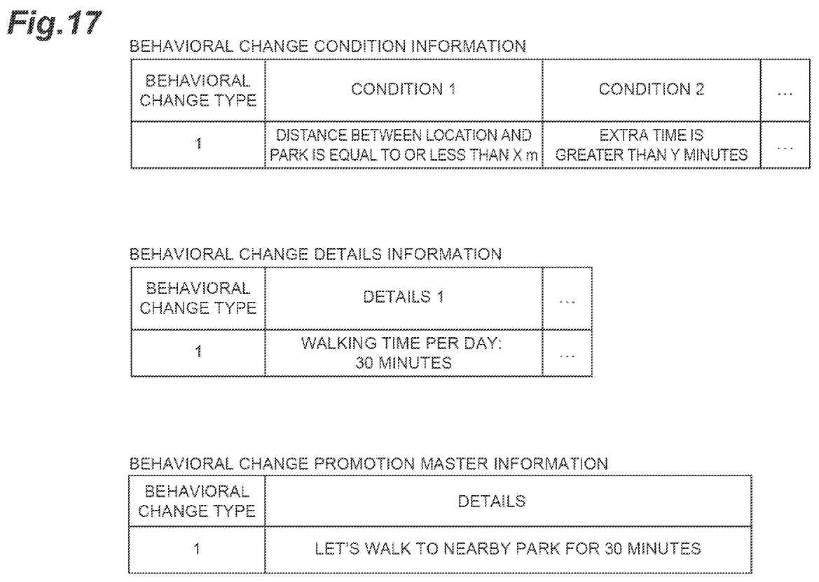

When the target state is “being healthy,” it is conceivable that behavioral change promotion details in the behavioral change promotion master information be “let's walk in a nearby park for 30 minutes” as illustrated in FIG. 17. It is conceivable that the behavioral change condition information includes “a distance between a location and a park is equal to or less than X m” (condition 1) and “an extra time is greater than Y minutes” (condition 2). The degree of execution is calculated with reference to the user information for whether a predetermined user satisfies such conditions. It may be considered that the behavioral change details information indicates “walk time per day: 30 minutes.” The degree of continuance is calculated by referring to the user information of the user for an average walk time per day (for example, an average walk time per day for recent several months) of a predetermined user and comparing the average walk time per day with the behavioral change details information.

The aspects/embodiments described in the present disclosure may be applied to a system using LTE (Long Term Evolution), LTE-A (LTE-Advanced), SUPER 3G, IMT-Advanced, 4G (4th generation mobile communication system), 5G (5th generation mobile communication system), FRA (Future Radio Access), W-CDMA (registered trademark), GSM (registered trademark), CDMA2000, UMB (Ultra Mobile Broadband), IEEE 802.11 (Wi-Fi (registered trademark)), IEEE 802.16 (WiMAX (registered trademark)), IEEE 802.20, UWB (Ultra-Wide Band), Bluetooth (registered trademark), or another appropriate system and/or a next-generation system which is extended based thereon.

The order of processing steps, the sequences, the flowcharts, and the like of the aspects/embodiments described above in the present disclosure may be changed unsmaller conflictions arise. For example, in the methods described in the present disclosure, various steps are described as elements in the exemplary order, and the methods are not limited to the described specific order.

Information or the like which is input or output may be stored in a specific place (for example, a memory) or may be managed using a management table. Information or the like which is input or output may be overwritten, updated, or added. Information or the like which is output may be deleted. Information or the like which is input may be transmitted to another device.

Determination may be performed using a value (0 or 1) which is expressed in one bit, may be performed using a Boolean value (true or false), or may be performed by comparison between numerical values (for example, comparison with a predetermined value).

The aspects/embodiments described in the present disclosure may be used alone, may be used in combination, or may be switched during implementation thereof. Notifying of predetermined information (for example, notifying that “it is X”) is not limited to explicit notification, and may be performed by implicit notification (for example, notifying of the predetermined information is not performed).

Regardsmaller of whether it is called software, firmware, middleware, microcode, hardware description language, or another name, software can be widely construed to refer to a command, a command set, a code, a code segment, a program code, a program, a sub program, a software module, an application, a software application, a software package, a routine, a sub routine, an object, an executable file, an execution thread, a sequence, a function, or the like.

Software, commands, information, and the like may be transmitted and received via a transmission medium. For example, when software is transmitted from a website, a server, or another remote source using at least one of wired technology (such as a coaxial cable, an optical fiber cable, a twisted-pair wire, or a digital subscriber line (DSL)) and wiresmaller technology (such as infrared rays or microwaves), the at least one of wired technology and wiresmaller technology is included in definition of the transmission medium.

Information, signals, and the like described in the present disclosure may be expressed using one of various different techniques. For example, data, instructions, commands, information, signals, bits, symbols, and chips which can be mentioned in the overall description may be expressed by a voltage, a current, electromagnetic waves, a magnetic field or magnetic particles, a photo field or photons, or an arbitrary combination thereof.

Terms described in the present disclosure and terms required for understanding the present disclosure may be substituted with terms having the same or similar meanings.

Information, parameters, and the like described above in the present disclosure may be expressed using absolute values, may be expressed using values relative to predetermined values, or may be expressed using other corresponding information.

A communication terminal may also be referred to as a mobile communication terminal, a subscriber station, a mobile unit, a subscriber unit, a wiresmaller unit, a remote unit, a mobile device, a wiresmaller device, a wiresmaller communication device, a remote device, a mobile subscriber station, an access terminal, a mobile terminal, a wiresmaller terminal, a remote terminal, a handset, a user agent, a mobile client, a client, or several other appropriate terms by those skilled in the art.

The expression “based on ˜” used in the present disclosure does not mean “based on only ˜” unsmaller otherwise described. In other words, the expression “based on ˜” means both “based on only ˜” and “based on at least ˜.”

No reference to elements named with “first,” “second,” or the like used in the present disclosure generally limits amounts or order of the elements. These naming can be used in the present disclosure as a convenient method for distinguishing two or more elements. Accordingly, reference to first and second elements does not mean that only two elements are employed or that a first element precedes a second element in any form.

When the terms “include” and “including” and modifications thereof are used in this specification or the claims, the terms are intended to have a comprehensive meaning similarly to the term “comprising.” The term “or” used in this specification or the claims is not intended to mean an exclusive logical sum.

In the present disclosure, two or more of any devices may be included unsmaller the context or technical constraints dictate that only one device is included.

In the entire present disclosure, singular terms include plural referents unsmaller the context or technical constraints dictate that a unit is singular.

### REFERENCE SIGNS LIST

1 . . . Behavioral change promotion device
14 . . . Calculation unit
16 . . . Selection unit
18 . . . Promotion unit

1. A behavioral change promotion device for prompting each predetermined target user to perform a behavioral change, the behavioral change promotion device comprising:
a calculation unit configured to calculate a degree of continuance indicating continuance/discontinuance and a behavior change effect indicating an effect when a behavioral change is performed for each of a plurality of predetermined behavioral change types based on first user information including features of the target user for each target user;
a selection unit configured to select a behavioral change type to be presented to a user out of the plurality of behavioral change types based on the degree of continuance and the behavioral change effect calculated by the calculation unit for each target user; and
a promotion unit configured to promote a behavioral change for each user based on the behavioral change type to be presented to the user selected by the selection unit.

2. The behavioral change promotion device according to claim 1, wherein the calculation unit compares behavior details associated with the plurality of behavior change types with behavior details indicated by the first user information for each target user and increases the degree of continuance for a behavioral change type with a smaller difference in behavior details.

3. The behavioral change promotion device according to claim 2, wherein the calculation unit identifies habitual behavior details which are habituated behavior details by collecting the behavior details indicated by the first user information collected in a predetermined period, compares the behavior details associated with the plurality of behavioral change types with the habitual behavior details, and increases the degree of continuance for a behavioral change type with a smaller difference in behavior details for each target user.

4. The behavioral change promotion device according to claim 1, wherein the calculation unit calculates the degree of continuance repeatedly at intervals of a predetermined time.

5. The behavioral change promotion device according to claim 1, wherein the calculation unit constructs a continuance degree estimation model for calculating the degree of continuance by learning second user information including features of each training user and information on continuance/discontinuance of each of the plurality of behavioral change types for each training user in correlation with the corresponding training user, and
wherein the calculation unit calculates the degree of continuance of each of the plurality of behavioral change types for each target user by inputting the first user information to the continuance degree estimation model.

6. The behavioral change promotion device according to claim 1, wherein the calculation unit generates behavioral change execution/non-execution information indicating a probability level as behavior details of each training user for each of the plurality of behavioral change types by comparing behavior details of a user indicated by second user information including features of each training user with behavior details associated with the plurality of behavioral change types,
wherein the calculation unit constructs a behavioral change effect estimation model for calculating the behavioral change effect by learning the second user information, the behavioral change execution/non-execution information for each of the plurality of behavioral change types, and a degree of achievement of a target state in the corresponding behavioral change in correlation with the corresponding training user, and
wherein the calculation unit calculates the behavioral change effect of each of the plurality of behavioral change types for each target user by inputting the first user information to the behavioral change effect estimation model.

7. The behavioral change promotion device according to wherein the calculation unit additionally calculates a degree of execution indicating execution/non-execution of each of the plurality of behavioral change types based on the first user information for each target user, and
wherein the selection unit selects the behavioral change type to be presented to a user based on the degree of continuance, the behavioral change effect, and the degree of execution calculated by the calculation unit for each target user.

8. The behavioral change promotion device according to claim 7, wherein the calculation unit determines whether behavior details of a user indicated by the first user information satisfy execution conditions of the behavior details associated with the plurality of behavioral change types for each target user and calculates the degree of execution of each of the plurality of behavioral change types based on a degree of satisfaction.

9. The behavioral change promotion device according to claim 7, wherein the calculation unit decreases the degree of execution of a behavioral change type with a greater time difference between a behavioral change promotion timing of each of the plurality of behavioral change types and a behavioral change execution timing of each of the plurality of behavioral change types.

10. The behavioral change promotion device according to claim 7, wherein the calculation unit constructs an execution degree estimation model for calculating the degree of execution by learning second user information including features of each training user and information on execution/non-execution of each of the plurality of behavioral change types for each training user in correlation with the corresponding training user, and
wherein the calculation unit calculates the degree of execution of each of the plurality of behavioral change types for each target user by inputting the first user information to the execution degree estimation model.
